(19) United States
(12) Patent Application Publication
(10) Pub. No.: US 2023/0107513 A1
(43) Pub. Date: Apr. 6, 2023

(54) Vertical Latch Bolt

(71) Applicant: C. R. Laurence Co, Inc., Los Angeles, CA (US)

(72) Inventor: Mirjana Komadina, Los Angeles, CA (US)

(73) Assignee: C. R. Laurence Co, Inc., Los Angeles, CA (US)

(21) Appl. No.: 17/880,451

(22) Filed: Aug. 3, 2022

Related U.S. Application Data
(60) Provisional application No. 63/252,038, filed on Oct. 4, 2021.

(51) Int. Cl. E05B 65/10

(52) U.S. Cl. CPC E05B 65/1006; E05B 65/1053

(57) ABSTRACT

An improved roller latch bolt that asymmetrically locates the roller within a roller support is presented. The improved design allows for a roller to make contact with a ramp surface of a corresponding strike plate on a sweep side of the plate and allows for the roller support to make contact with the strike plate on a latch side of the plate. The improved roller latch bolt maintains the smooth operation of roller latch bolts while also providing the increased door security and other benefits of non-roller latch bolts.

### CROSS-REFERENCE TO RELATED APPLICATIONS

This utility patent application claims priority to U.S. Provisional Patent Application No. 63/252,038, titled “Vertical Latch Bolt,” filed Oct. 4, 2021, the contents of which are incorporated by reference herein in its entirety.

### BACKGROUND OF THE INVENTION

### Field of the Invention

The present invention relates generally to vertical latch bolts for use in door latch mechanisms, and more specifically, to an improved roller-head vertical latch bolt having improved resistance to attempts at forced entry.

### Background of the Invention

A latch bolt is a component of a door latch assembly. Latch bolts typically are spring loaded and engage a strike plate mounted in a door frame. Latch bolts also, typically, have a head portion comprising, in horizontal latch configurations, an angled face that allows the latch bolt to ride up an angled ramp in the strike plate prior to engaging a socket or hole in the strike plate. The latch bolt is spring loaded to allow the bolt to depress into the lock mechanism while it engages the ramp of the strike plate. Being spring loaded, the latch bolt automatically extends into the socket of the strike plate upon clearing the ramp. Typically, a latch assembly will have a mechanism that retracts or disengages the latch bolt from the socket of the strike plate upon the operation of a door handle, thereby allowing the door to open.

Horizontal door latch assemblies as described above are commonly used with the doors of residential buildings. Vertical door latches are door latches commonly used in commercial and public buildings. In a vertical door latch installation, vertical door latches are located at either the top or bottom edges of the door and not infrequently, at both the top and bottom edges. Vertical rod door latch assemblies are designed to include vertically oriented latch bolts that extend upwardly out of the top edge of the door or extend downwardly from the bottom edge of the door. Similar to horizontal latch bolts, vertical latch bolts extend from a door into an opening in a strike plate. As with their horizontally oriented counterparts, vertical latch bolts are also typically spring loaded and their corresponding strike plates also include ramps that depress the latch bolts prior to engagement with the sockets of the strike plates. Some vertical latch bolts differ from horizontal latch bolts in that it is common for the head portion of such vertical latch bolts to feature a roller rather than an angled face for engaging the angled ramp of the strike plate. In the case of vertical latch assemblies, the strike plates may be located in the door frame or may be located in the floor or in the building's ceiling.

Vertical latch bolts are typically driven into and out of engagement with their corresponding strike plates by vertical rods extending from an actuator located near the midpoint of the door. For aesthetic reasons, the vertical rods are often hidden inside the door or, in the case of glass doors, hidden in vertical door handles on the outside of the door.

In typical operation, when a door closes the spring-loaded vertical latch bolts ride up the ramps of their strike plates and automatically, under the force of their biasing springs, engage the sockets of the corresponding strike plates. Therefore, vertical latch assemblies, like their horizontal counterparts, require an actuator to retract the spring-loaded latch bolts from the sockets of the strike plates when the door is to be opened. This actuator is typically in the form of a push bar or push rail mounted horizontally on the door, where the push bar or push rail interfaces with the vertical door rods and includes a mechanism that translates the lateral motion of the push bar or rail into vertical motion to operate the vertical rods and the latch bolts connected thereto.

An issue that arises in doors featuring vertical latch assemblies is whether to use latch bars with roller heads or those with angled faces, i.e., non-roller heads. Roller latch bolts are well-known for their smooth operation and are known to be effective in securing a door. Non-roller latch bolts, which use angled faces to engage the strike plates, require, generally, more force to operate and have a less smooth “feel” in operation in comparison to roller latch bolts due to the sliding nature of their engagement with the strike plates. A non-roller latch bolt having an angled face, may, however, offer more security than a roller latch bolt when engaged in its strike plate. Although both types of latch bolt work well, there remains room for improvement in the art. What is needed is a latch bolt that combines the smooth operation of a roller head latch bolt with the potential increase in security offered by a non-roller latch bolt having an angled face.

### SUMMARY OF THE INVENTION

The present invention improves upon the prior art by providing an improved roller latch bolt that combines the low force and smooth operation of prior art roller latch bolts with the potential increase in security offered by prior art non-roller latch bolts.

The improved roller latch bolt of the present invention asymmetrically locates the roller within a roller support bracket. Asymmetric location of the roller allows for the roller to make contact with a ramp surface of a corresponding strike plate on a sweep side of the plate and allows for the roller support bracket to make contact with a vertical latch surface of the strike plate on a latch side of the plate, when the improved roller latch bolt is disposed within the socket of the strike plate. The improved latch bolt maintains the smooth operation of prior art roller latch bolts while also providing the increased door security and other benefits of prior art non-roller latch bolts.

The above and other advantages of the improved roller latch bolt of the present invention will be described in more detail below.

### BRIEF DESCRIPTION OF THE DRAWINGS

FIG. 1 is a perspective view of a representative glass door having a representative latch bolt release mechanism installed.

FIG. 2 is a cross-sectional view, taken along the line A-A of FIG. 1 of the glass door of FIG. 1, of the representative glass door and representative latch bolt mechanism and a latch bolt in accordance with the present invention.

FIG. 3A is a side view of a prior art non-roller latch bolt.

FIG. 3B is a front view of the prior art non-roller latch bolt of FIG. 3A.

FIG. 4A is a side view of a prior art roller latch bolt.

FIG. 4B is a front view of the prior art roller latch bolt of FIG. 4A.

FIG. 5A is a side view of the improved roller latch bolt of the present invention.

FIG. 5B is a front view of the improved roller latch bolt of FIG. 5A.

FIG. 5C is a top view of an alternative embodiment of the improved roller latch bolt of the present invention.

FIG. 5D is a top view of the alternative embodiment of the improved roller latch bolt of FIG. 5C.

FIG. 6A is a side view of a prior art non-roller latch bolt engaging a ramp of a strike plate.

FIG. 6B is a side view of the prior art non-roller latch bolt of FIG. 6A seated in the socket of a strike plate.

FIG. 7A is a side view of a prior art roller latch bolt engaging a ramp of a strike plate.

FIG. 7B is a side view of the prior art roller latch bolt of FIG. 7A seated in the socket of a strike plate.

FIG. 8A is the improved roller latch bolt of the present invention engaging a ramp of a strike plate.

FIG. 8B is a side view of the improved roller latch bolt of the present invention seated in the socket of a strike plate.

### DETAILED DESCRIPTION OF THE PREFERRED EMBODIMENTS

The present invention will now be described more fully hereinafter with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

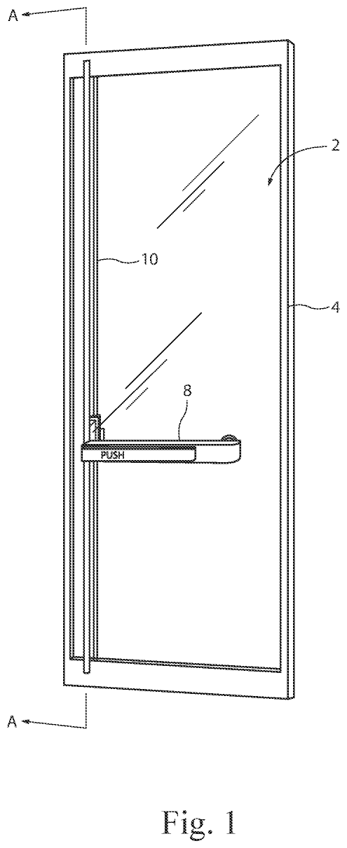

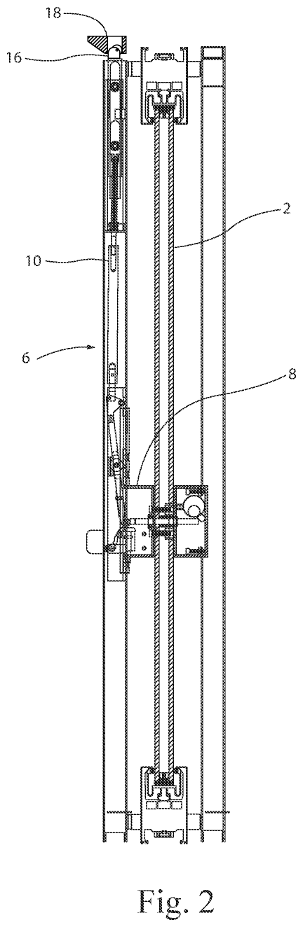

With reference to FIGS. 1 and 2, for background, a representative glass door 2 having a representative door opening mechanism 6, comprising a representative push bar actuation mechanism 8 and a representative latch bolt release mechanism 10 are shown in stalled in a representative door support structure 4. With particular reference to FIG. 2, an improved roller latch bolt 16 of the present invention is shown installed in the representative latch bolt release mechanism 10. A latch bolt release mechanism suitable for use with the improved roller latch bolt 16 of the present invention is described in U.S. Pat. No. 11,118,378 entitled Push Pad Exit Device for Emergency Door Egress, issued on Sep. 14, 2021, and assigned to C. R. Laurence, Co., Inc.

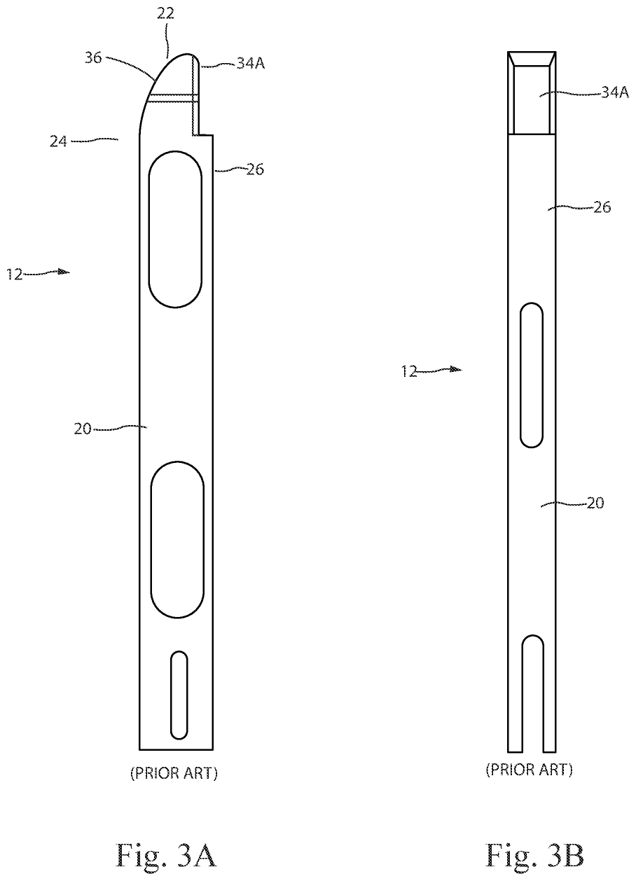

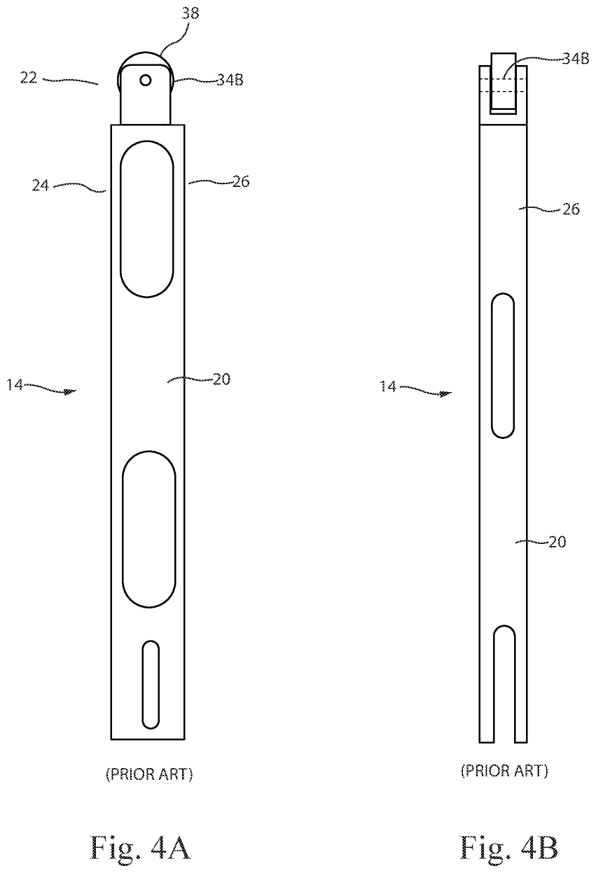

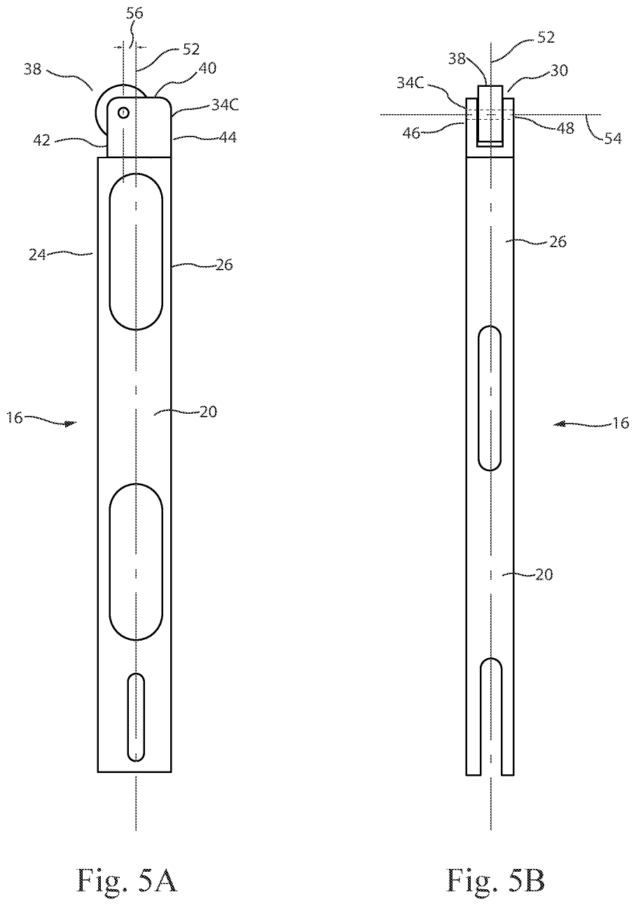

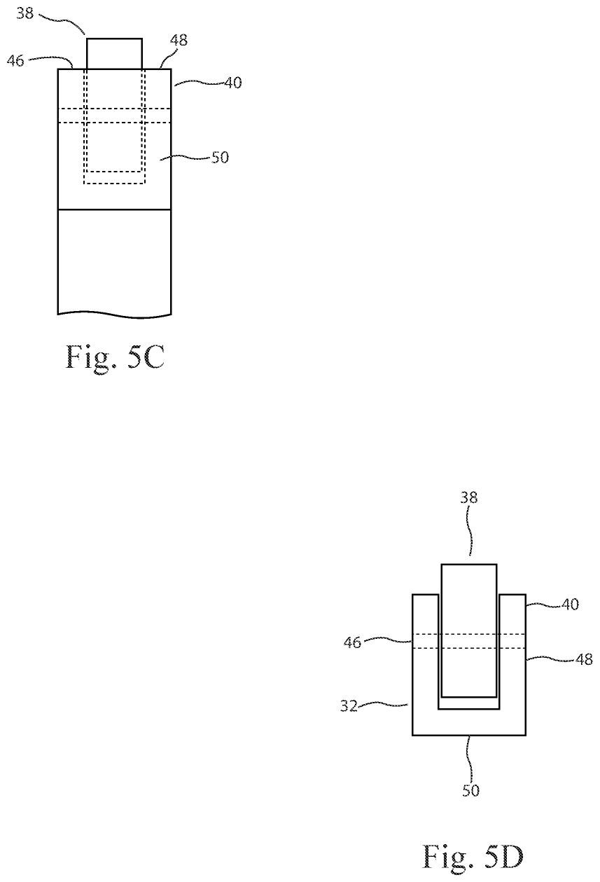

FIGS. 3A-3B show a schematic representation of a prior art non-roller latch bolt 12. FIGS. 4A-4B show a schematic representation of a prior art roller latch bolt 14 and FIGS. 5A to 5B show a schematic representation of the improved roller latch bolt 16 of the present invention. Actual physical implementations of the prior art latch bolts will vary depending upon the manufacturer and specific application.

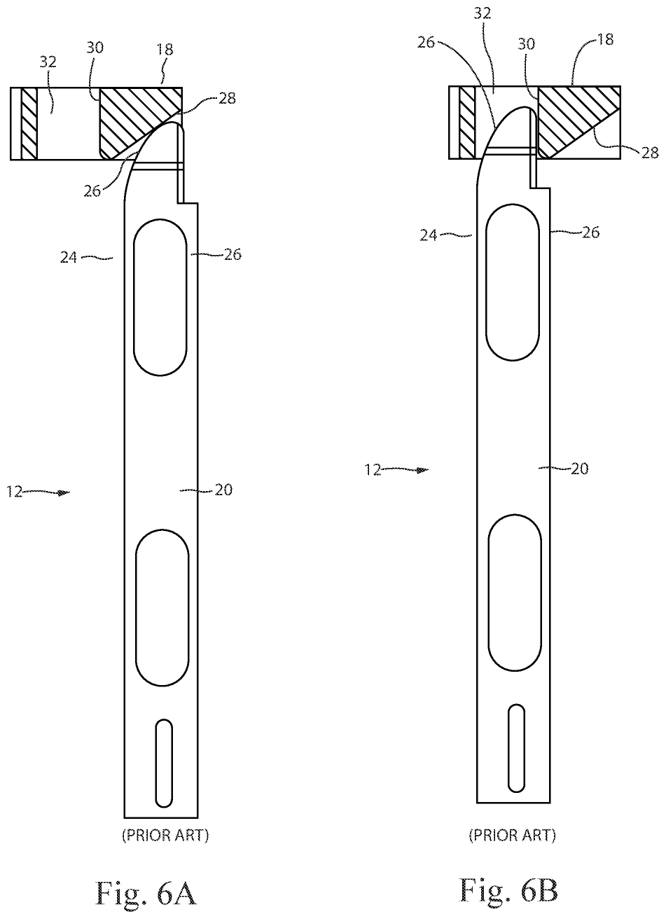

With reference to FIGS. 3A to 5B, as shown schematically, the prior art non-roller latch bolt 12 and prior art roller latch bolt 14 and the improved roller latch bolt 16 of the present invention have, generally, the following features in common. Each latch bolt has a body portion 20, a head portion 22, a sweep side 24 and a latch side 26. The sweep side 24 of each latch bolt corresponds to the side of the latch bolt that engages a ramp 28 of a strike plate 18. (See FIGS. 6A, 7A and 8A.) The latch side 26 of each latch bolt corresponds to the side of the bolt that engages a latch surface 30 of the strike plate 18.

The body portion 20 of a latch bolt is engageable, typically, via a vertical rod, with a latch bolt release mechanism 10 that is configured to move the latch bolt towards or away from a corresponding strike plate 18. Latch bolt release mechanisms will also typically have an adjustment feature that allows the depth of engagement of the latch bolt with its corresponding strike plate to be adjusted. Such latch release mechanisms are disclosed in U.S. Pat. Nos. 4,366,974; 4,382,620; 4,418,949; 4,506,922; 6,511,104 and 6,726,257, and are well-known in the art.

Latch bolts, as installed in a representative latch release mechanism 10, are also typically spring loaded. Thus, as a door equipped with a vertical latch bolt closes, the spring-loaded latch bolt rides along the ramp 28 of the strike plate 18 and is depressed into the latch release mechanism 10. As the latch bolt transitions from the ramp 28 into a socket 32 of the strike plate 18, the biasing springs of the latch bolt release mechanism bias the latch bolt upwardly into the socket 32 of the strike plate 18. Therefore, the effort and smoothness of operation of a door equipped with a vertical door latch assembly is dependent upon the interface between the sweep side 24 of the latch bolt and the ramp 28 of the strike plate 18. Generally, rolling action will generate less friction and, therefore, produce a smoother operation than sliding action and require less force to close.

With reference to FIGS. 3A to 8A, the security of the connection between a latch bolt and a strike plate 18, depends upon the interface between a contact surface on the latch side 26 of the latch bolt and the latch surface 30 of the strike plate 18. The latch surface 30 of the strike plate 18 will typically be a flat vertical surface.

In the prior art roller latch bolt 14, line contact only exists between the latch surface 34B and the latch surface 30 of the strike plate 18. That is, the contact surface 34B between the prior art latch bolt 14 and the latch surface 30 is effectively minimized to a line, i.e., the line of points along the width of the circular roller that are tangent to the plane occupied by the latch surface 30. This minimization of the contact area offers less tolerance when installing and adjusting the latch bolt because the closer the line of contact between the prior art latch bolt 14 and the latch surface 30 to the lower boundary of the socket 32, the more vulnerable the door may be to “forced entry,” which, as used herein, refers to any force attempting to open the door without first releasing the latch.

While less friction, less force, and smoothness are desirable when closing the door, they are not desirable attributes when seeking to secure the door opening. A minimal contact area not only provides less tolerance when installing and adjusting the latch bolt, but it also focuses all of the force generated from forced entry into a concentrated area instead of spreading it out over a larger surface. This concentration of force onto a smaller area makes the latch release mechanism more susceptible to damage and possible failure. Therefore, latch bolt designs that maximize the contact area between the latch face of the latch bolt and the latch surface of the strike plate may have an advantage in that they provide more tolerance in installing and adjusting the latch, more force may be required to force entry through the door or otherwise open it without first releasing the latch, and such force, being spread out offer a larger area, is less of a threat to the structural integrity of the latch assembly.

With reference to FIGS. 3A-3B and 6A-6B, in prior art non-roller latch bolts 12, the sweep side 24 of the head portion 22 is typically equipped with an angled face or curved face. In the prior art non-roller latch bolt 12 of FIG. 1A, the sweep side 24 of the head portion 22 is configured as a curved surface 36. The curved surface 36 slides along the length of the ramp 28 of the strike plate 18. Although efforts may be made to minimize friction between the two surfaces, sliding motion is inherently not as smooth as rolling motion and a door equipped with a non-roller latch bar requires more effort to close than a door with a roller latch bar. Also, as the two sliding surfaces wear over time, friction between the surfaces increases and consequently, door closing effort increases and smoothness of operation decreases over time in non-roller latch bar equipped doors.

An advantage however, of a non-roller latch bolt, such as prior art non-roller latch bolt 12 shown in FIGS. 3A-3B and 6A-6B is that such latch bolts have a contact surface 34A that is a flat face. The flat face contact surface 34A abuts the equally flat latch surface 30 of the strike plate 18 which creates a connection that, due to having a large contact area between the abutting surfaces, is resistant to attempts at forced entry.

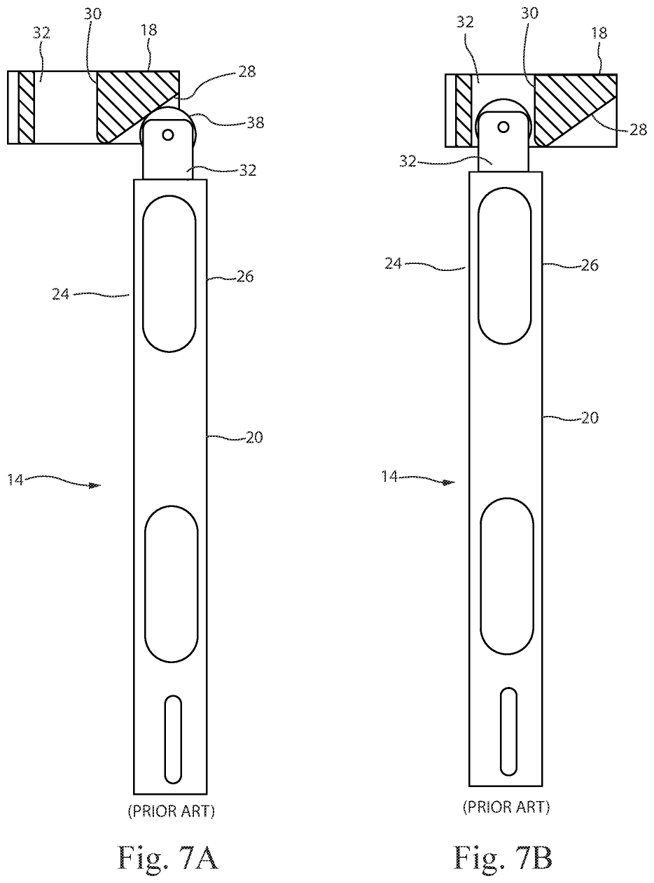

With reference to FIGS. 4A-4B and 7A-7B, in the prior art roller latch bolt 14, the head portion 22 comprises a roller 38, instead of a curved surface. Thus, the sweep side 24 and the latch side 26 of the prior art roller latch bolt 14 present a cylindrical contact surface to the ramp 28 and latch surface 30 of the strike plate 18. The prior art roller latch bolt 14 has certain advantages and disadvantages in comparison to the prior art non-roller latch bolt 12.

In particular, with the prior art roller latch bolt 14, the roller 38 engages the ramp 28 of the strike plate 18. Due to rolling engagement of these two surfaces, door operation with the prior art roller latch bolt 14 is smoother and requires less effort than that of a door equipped with the non-roller latch bolt 12. On the other hand, when the prior art roller latch bolt 14 is seated within the socket 32 of the strike plate 18, there is, as previously indicated, only line contact between the roller 38 and the latch surface 30. Because only line contact exists at this interface and because there is some flexibility inherent in a door and door frame, doors equipped with prior art roller latch bolts may be less secure, i.e., may more easily be forced open, or subject to forced entry, than doors equipped with non-roller latch bolts. As previously indicated, they may also be more susceptible to damage or failure and offer less tolerance in installation and adjustment.

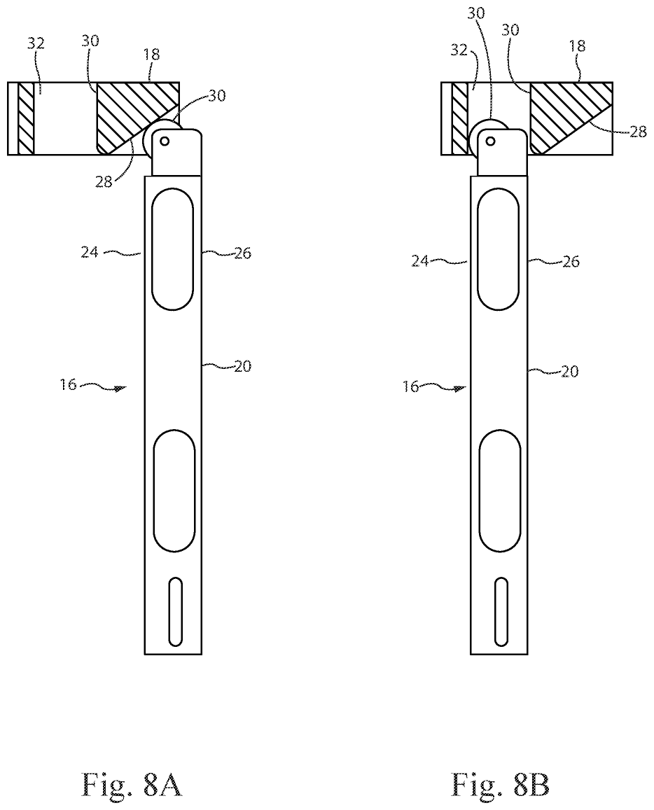

With reference to FIGS. 5A-5B and 8A-8B, the improved roller latch bolt 16 of the present invention combines the advantages of both prior art roller latch bolts, such as prior art roller latch bolt 14, and prior art non-roller latch bolts, such as prior art non-roller latch bolt 12. In the new design, the head portion 22 of the improved roller latch bolt 16 of the present invention includes a roller support 40, configured so that the roller 38 is asymmetrically located within the roller support, such that on a sweep side 42 of the roller support 40, the roller 38 protrudes from the roller support 40 and on a latch side 44 of the roller support 40, the roller 38 does not extend beyond the roller support 40.

With particular reference to FIGS. 5A-5B, the body portion 20 of the improved roller latch bolt 16 of the present invention has a longitudinal axis 52 and the roller 38 has an axis of rotation 54. In this improved configuration, the axis of rotation 54 of the roller 38 is perpendicular to the longitudinal axis 52 of the body portion 20 and is offset from the longitudinal axis 52. That is, the roller 38 has a transverse offset 58 from the longitudinal axis 53 of the body portion 20. (See FIG. 5A.)

The asymmetric positioning of the roller 38 on the improved roller latch bolt 16 of the present invention provides for rolling engagement between the latch bolt and the strike plate 18. That is, the roller 38 of the latch bolt engages with the ramp 28 of the strike plate 18 and consequently provides for smoother door operation and lower door closing force. The asymmetric positioning also, however, allows the latch side 44 of the roller support 40 to extend beyond the roller 38. Consequently, as shown in FIG. 8B, when the improved roller latch bolt 16 of the present invention is seated within the socket 32 of the strike plate 18, the contact surface 34C of the roller support 40 that engages the latch surface 30 of the strike plate is a flat surface.

The flat contact surface 34C of the improved roller latch bolt 16 of the present invention significantly increases the area in contact between the contact surface 34C and the latch surface 30 of the strike plate 18 in comparison to that of the prior art roller latch bolt 14, which only provides line contact at the interface between the contact surface 34B, i.e. a roller, and the latch surface 30 of the strike plate 18.

The roller support 40 may be configured as a dual support, i.e. as a pair of upright supports 46 and 48 (see FIG. 5B), which may, optionally, include a contact plate 50 that spans and interconnects the supports 46 and 48 (see FIG. 5C) and is parallel to the axis of rotation of the roller. In the exemplary embodiment, the contact plate 50 is co-planer with a side of the body portion 20. The roller support 40 may also be configured as single upright support with the roller 38 rotatably connected thereto.

In the dual support configuration (see FIG. 5B), the end faces of the supports 46 and 48 function as contact surfaces 34C. As the contact surfaces 34C are flat surfaces, substantially more contact area is provided between the contact surfaces 34C and the latch surface 30 of the strike plate 18, than is provided by prior art roller latch bolts, such as prior art latch bolt 14, which provides only line contact between the contact surface and the latch surface 30, i.e., with prior art roller latch bolts, only the roller 38 bears against the latch surface 30 of the strike plate 18. In the dual support with contact plate configuration (see FIGS. 5C and 5D), the contact plate 50 provides fully the same or more surface contact area as is provided by prior art non-roller latch bolts, such as prior art non-roller latch bolt 12.

Increased surface contact area between the latch bolt and the latch surface of the strike plate improves door security as more force is believed to be needed to force open the door than would be required with prior art roller latch bolts that provide for line contact only. In addition, spreading the force over a greater area protects the latch assembly from damage or failure.

In all configurations of the roller support 40, the roller 38 is rotatably connected to the roller support by means of bolts or pins or other means known in the art. Likewise bearings or bushings may be used in the support or supports to decrease friction between the bolts or pins, as is also known in the art.

It will be appreciated that an improved roller latch bolt that combines the advantages of prior art roller and non-roller latch bolts without any of the disadvantages of either prior art design, has been presented.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments.

1. An improved roller latch bolt for use in a latch mechanism, comprising:
a latch bolt body having a longitudinal axis and a roller having an axis of rotation;
wherein a plane on which the axis of rotation extends is perpendicular to a plane on which the longitudinal axis extends
wherein the axis of rotation is offset from the longitudinal axis;
wherein the roller is supported by two supports with the roller disposed between the supports;
wherein a contact plate bridges the supports and is parallel to the axis of rotation of the roller; and
wherein the contact plate is co-planer with a side of the latch bolt body.

2. (canceled)

3. (canceled)

4. (canceled)

5. An improved roller latch bolt for use in a door latch mechanism, comprising:
a latch bolt body, a roller support, and a roller;
the latch bolt body having a longitudinal axis, a sweep side and a latch side;
the roller having an axis of rotation;
wherein a plane on which the axis of rotation extends is perpendicular to a plane on which the longitudinal axis extends;
wherein the axis of rotation is offset from the longitudinal axis;
wherein the roller support comprises two support plates, the roller disposed between the support plates and rotatably connected to the support plates; and
wherein the roller extends outwardly from the support plates on the sweep side of the latch bolt body and does not extend outwardly from the support plates on the latch side of the latch bolt body.

6. (canceled)

7. The improved roller latch bolt for use in a door latch mechanism of claim 5, wherein the support plates are bridged by a contact plate, wherein the contact plate is parallel to the axis of rotation of the roller.

8. The improved roller latch bolt for use in a door latch mechanism of claim 7, wherein the contact plate is co-planer with a side of the latch bolt body.

9. (canceled)

10. (canceled)

11. (canceled)

12. The improved roller latch bolt for use in a latch mechanism of claim 1, wherein the latch bolt body has a sweep side and a latch side, wherein the roller extends outwardly from the supports on the sweep side and does not extend outwardly from the supports on the latch side.
